(19) United States
(12) Patent Application Publication
(10) Pub. No.: US 2011/0046934 A1
(43) Pub. Date: Feb. 24, 2011

(54) MONITORING A REGION OF INTEREST IN A SUBSURFACE FORMATION

(76) Inventors: Paul James Hatchell, Rijswijk (NL); Peter Berkeley Wills, Rijswijk (NL)

Correspondence Address: SHELL OIL COMPANY, P O BOX 2463, HOUSTON, TX, 772522463, US

(21) Appl. No.: 12/675,142

(22) PCT Filed: Aug. 27, 2008
(86) PCT No.: PCT/EP2008/061194

§ 371 Date: Feb. 25, 2010

(30) Foreign Application Priority Data
Aug. 28, 2007 (EP) 07115092.4

(51) Int. Cl. G06G 7/57; G06G 7/48

(52) U.S. Cl. 703/10; 703/6

(57) ABSTRACT

A method of monitoring a subsurface formation (2) including a region of interest (1), below a surface region, which method comprises the steps of exciting seismic interface waves (14), in the surface region over an area of the earth's surface at a first and a second moment in time; detecting seismic interface waves signals for a plurality of locations in the area; determining, from the detected seismic interface wave signals, an areal distribution of a parameter related to seismic interface wave velocity change between the first and second moments in time; and inferring, from the areal distribution, an indication of a volume change of the region of interest between the first and second moments in time.

The present invention relates to a method of monitoring a region of interest in a subsurface formation, which region of interest undergoes a volume change. The region of interest can in particular be a reservoir region, and the volume change can be caused by withdrawal of a fluid from or injection of a fluid into the reservoir region, or by a changing the temperature of the reservoir region.

### BACKGROUND OF THE INVENTION

There is a need for technologies that allow monitoring of depleting reservoir regions during production of hydrocarbons (oil and/or natural gas) from the reservoir. The geometric structure of a reservoir region in a subsurface formation is normally explored by geophysical methods, in particular seismic imaging of the subsurface during the exploration stage of an oil field. More difficult and less developed are methods that allow monitoring of the compaction of the depleting reservoir region in the course of production. One approach is to study the deformation such as displacement or tilt of the earth's surface above the region of the depleting reservoir. An example of such studies is the paper “Monitoring of fluid injection and soil consolidation using surface tilt measurements” by D. W. Vasco et al., Journal of Geotechnical and Geoenvironmental Engineering, January 1998, p. 29-37, and in this paper the estimation of subsurface volume changes given observations of surface displacement or tilt by inversion is discussed. Another example is the paper “Geodetic imaging: reservoir monitoring using satellite interferometry” by D. W. Vasco et al., Geophys. J. Int. (2002) vol 149, p. 555-571.

Another technology that is increasingly employed in recent years is time-lapse seismic surveying. In time-lapse seismic surveying, seismic data of the subsurface formation including the reservoir region are acquired at at least two points in time. Time is therefore an additional parameter with regard to conventional seismic surveying. This allows studying the changes in seismic properties of the subsurface as a function of time due to, for example, spatial and temporal variation in fluid saturation, pressure and temperature. Time-lapse seismic surveying is also referred to as 4 dimensional (or 4D) seismics, wherein time between acquisitions represents a fourth data dimension. Like in conventional seismic surveying, the three other dimensions relate to the spatial characteristics of the earth formation, two being horizontal length dimensions, and the third relating to depth in the earth formation, which can be represented by a length coordinate, or by a time coordinate such as the two-way travel time of a seismic wave from surface to a certain depth and back. Time-lapse seismic surveys study changes in seismic parameters over time, and in particular changes in two-way travel time can be studied. For repeated seismic surveying of a subsea formation, for example, ocean bottom cables forming an array of geophones and/or hydrophones can be installed at the sea bottom.

International Patent application with publication No. WO2005/040858 discloses a method of investigating an underground formation using a time-lapse seismic survey. It has been found, that changes in e.g. two-way travel time can be observed outside a depleting reservoir region in the underground formation. This is a result of the impact of the volume change, that corresponds to the depletion, on the stress distribution in the surrounding formation. Stress changes cause changes in the seismic parameter seismic velocity, and therefore also in two-way travel time. A strain model for time-lapse time shift is discussed in the paper “Rocks under strain: Strain-induced time-lapse time shifts are observed for depleting reservoirs”, P. Hatchell and S. Bourne, The Leading Edge, December 2005, p. 1222-1225, and this strain model can be used to calculate the compaction of the depleting reservoir region. The calculation of a compaction map from a time-lapse seismic timeshift data is discussed in Hatchell, P. J., and S. J. Bourne, 2005, Measuring reservoir compaction using time-lapse timeshifts: 75th Annual International Meeting, SEG, Expanded Abstracts, 2500-2503. A workflow for predicting time-lapse seismic attributes is described in J. Herwanger and S. Horne, Predicting time-lapse stress effects in seismic data, The Leading Edge, December 2005, p. 1234-1242.

A general difficulty in seismic surveying of oil or gas fields is that the reservoir region normally lies several hundreds of meters up to several thousands of meters below the earth's surface, but the thickness of the reservoir region or layer is comparatively small, i.e. typically only several meters or tens of meters. Sensitivity to detect small changes in the reservoir region is therefore an issue. Typically several years of production have to be awaited before clear differences can be detected and conclusions about reservoir properties can be drawn. Due to the depth, phenomena intermediate between the earth's surface and the reservoir can hamper the analysis, such as the presence of a gas cloud above the reservoir.

Issues similar to compaction of a depleting reservoir region arise in the case of an expansion of a subsurface region, in particular a reservoir region such as due to injection of a fluid into a subsurface formation, e.g. CO₂ or water, or heating a subsurface region, in which case the region will expand.

The method according to the preamble of claim 1 is known from U.S. patent application US 2006/0153005. The method known from this prior art reference is used to estimate stress fields in geological formations.

It is an object of the present invention to provide a method for monitoring a volume change in a subsurface formation in a more accurate manner than is achieved by the method known from US 2006/0153005.

Thus, there is a need for an improved method allowing the monitoring of a volume change in a subsurface formation.

### SUMMARY OF THE INVENTION

To this end the present invention provides a method of monitoring a subsurface formation including a region of interest below a surface region, which method comprises the steps of
exciting seismic interface waves in the surface region over an area of the earth's surface at a first and a second moment in time;
detecting seismic interface waves signals for a plurality of locations in the area;
determining, from the detected seismic interface wave signals, an areal distribution of a parameter related to seismic interface wave velocity change between the first and second moments in time; and
inferring, from the areal distribution, an indication of a volume change of the region of interest between the first and second moments in time
characterized in that a parameter related to a volume change is inferred from the areal distribution, using a model of the subsurface formation, in particular a geomechanical and/or reservoir model;
the areal distribution is a first areal distribution; and
the step of inferring an indication of a volume change comprises:
postulating a model for the subsurface formation including an assumption on the volume change of the region of interest between the first and second moments in time;
calculating, using the model, a second areal distribution, within the surface region of the subsurface formation above the region of interest, of a parameter related to the volume change of the region of interest between the first and second moments in time; and
comparing the first and second areal distributions so as to validate, dismiss, or refine the assumption on the volume change of the region.

The invention is based on the insight gained by applicant that seismic interface wave signatures are a sensitive means to detect stress changes in a surface region, which are caused by a volume change in a deeper region of the subsurface formation, such as a depleting reservoir.

Seismic interface waves, also referred to as seismic surface waves, are only present in a region at or near the earth's surface, where they travel involving a combination of longitudinal and transverse motion. A well-known type of seismic interface waves on land are so-called Rayleigh waves, and in case the earth's surface is the bottom of the sea, they are referred to as Scholte waves. Love waves are another type of surface wave. Other seismic interface waves are so-called “head waves”, sometimes also referred to as “diving waves”, which propagate along shallow layers, within 500 m below the seafloor. These waves are also “surface waves” in that they decay strongly away from the surface and weakly as a function of source/receiver separation. They can travel at or near either P or shear velocity. We have been able to invert P wave head waves, and they give reasonable maps that can also be compared to geomechanical models. Seismic interface waves that are being utilized by the present method are not seismic body waves, and decay slowly as a function of shot/receiver separation. Decaying slowly means typically that the energy of the wave is approximately decaying like 1/R, where R is the shot/receiver distance; 1/R is what one gets in a 2 d geometry because the waves travel on a surface and spread as a circle. A body wave has an energy decay like 1/R̂2, because the energy spreads into a spherical shell.

Being seismic waves, the velocity of the surface waves depends on the stress in a surface region of the subsurface formation. The depth of the surface region within which surface waves such as Scholte or Rayleigh waves can be detected depends on the frequency and the mode of the wave, but is typically less than 400 m, in many cases 300 m or less, 200 m or less, or 100 m or less. The upper horizon of the region of interest is typically at least 600 m deep, in most cases more than 1000 m deep, and is typically at least twice as deep as the surface region.

A volume change of the deep region of interest causes a change in the stress distribution in the surface region above. Areal mapping of a parameter related to surface wave velocity therefore allows to monitor the volume change, e.g. the lateral distribution of compaction or expansion signatures. The parameter related to surface wave velocity can be a surface wave velocity itself, or a related parameter such as a time shift of a seismic travel time. The indication of a volume change that is obtained with the method can be qualitative, but preferably is quantified by deriving a parameter related to the volume change of the region of interest, such as depletion or expansion of a reservoir region. Other parameters of interest can relate to faulting patterns in the overburden above a depleting region; knowledge of such patterns allows optimising suitable well locations for trouble-free drilling through the overburden. Suitably the indication is subsequently stored, displayed, outputted or transmitted.

Suitably the interpretation of the areal distribution is facilitated by modeling of the subsurface formation, in particular for determining an estimate of a parameter related to the volume change. When a model is postulated for the subsurface formation including an assumption on the volume change of the region of interest between the first and second moments in time, a second areal distribution of a parameter related to the volume change of the region of interest between the first and second moments in time can be determined, at least within the surface region of the subsurface formation above the region of interest, and compared with the areal distribution of the parameter derived from the seismic surface wave measurements. The model can in particular be a geomechanical and/or reservoir model. The second areal distribution can be an areal distribution of stress or strain in the surface region, or can be a prediction of seismic surface wave velocity, its anisotropy (such as defined by one or more parameters that give the variation of this velocity with azimuth) or a related parameter such as P and/or shear velocity anisotropy which themselves can be computed from a strain field using a rock property model. By comparing the areal distributions obtained from the surface wave measurements and from the model, the assumption in the model regarding the volume change of the region of interest can be validated, dismissed, or refined.

The calculated parameter related to volume change can for example be a stress change parameter, a strain, anisotropy of a seismic wave velocity (surface wave, P and/or S wave), or a predicted parameter related to seismic surface wave velocity change. In the latter case, the measured and predicted parameters can be directly compared. The parameter related to seismic surface wave velocity change is seismic surface wave velocity change, or a seismic surface wave travel time change.

Seismic surface velocity change of at least two different modes of seismic surface velocity can be taken into account, this can be advantageous because the modes probe surface velocity at different depths in the surface region.

In special embodiments an estimate of at least one of compaction or expansion of the region of interest, location of a lateral edge of a the region of interest, fluid depletion or fluid enrichment of a reservoir region in the subsurface formation, fluid connectivity between a plurality of regions in the subsurface formation is inferred. Preferably a 1D, 2D or 3D distribution of the estimate is determined.

The method is applied with advantage when the subsurface formation comprises a reservoir region, for example a hydrocarbon reservoir, and wherein the volume change takes place in the course of production of a fluid from or injection of a fluid into the fluid reservoir, or in the course of modifying the temperature of the reservoir region.

In many cases a further data set is acquired for the subsurface formation, such as conventional time-lapse seismic data or geodetic deformation data of the earth's surface, and then the change in surface wave velocity can be compared with and/or processed together with the further data set in order to infer the indication of the volume change.

The invention also provides a method for producing hydrocarbons from a subsurface formation underneath a sea bed, wherein the subsurface formation is monitored by the method of the invention.

The subsurface formation can in particular be a subsea formation. The earth's surface is then the bottom of the sea.

### BRIEF DESCRIPTION OF THE DRAWINGS

An embodiment of the invention will now be described in more detail and with reference to the accompanying drawings, wherein

FIG. 1 shows a schematic representation of a subsea seismic survey;

FIG. 2 shows a representation of seismic surface wave data obtained for a fixed geophone location and varying source locations;

FIG. 3 shows a representation of seismic surface wave time shift for a fixed geophone location and varying source locations;

FIG. 4 shows a first areal distribution of measured Scholte wave velocity change in an area above a depleting hydrocarbon reservoir region; and

FIG. 5 shows a second areal distribution of calculated Scholte wave velocity change in the same area as FIG. 4.

Where the same reference numerals are used in different Figures, they refer to the same or similar objects.

### DETAILED DESCRIPTION OF THE INVENTION

Although surface waves are typically generated along with body waves in conventional seismic surveying, they are not often processed and interpreted. The paper “Scholte wave velocity inversion for a near surface S-velocity model and PS-statics” by E. Muyzert; Soc. of Expl. Geophys.; 70^{th} Ann. Internat. Mtg. 2000, p. 1197-1200, incorporated herein by reference, discusses fundamental aspects of Scholte waves such as frequency dependence, depth penetration, and fundamental and higher modes, and discloses a method for constructing a S-velocity model of the shallow seabed that laterally varies along one horizontal dimension, using Scholte waves.

The paper “Multichannel analysis of surface waves (MASW)- active and passive methods” by C. B. Park et al., The Leading Edge, January 2007, p. 60-64, discusses the frequency-dispersion analysis of land surface waves to investigate shallow soil layers, for geotechnical application, such as construction sites, with a maximum depth of 30 m.

In a recent paper “Scholte-wave tomography for shallow water-marine sediments” by S. Kugler et al.; Geophys. J. Int. (2007) 168, p. 551-570, incorporated herein by reference, a theoretical approach to Scholte-wave tomography is discussed. From Scholte-wave field data, a 3D shear-wave velocity structure of shallow-water marine sediments is estimated.

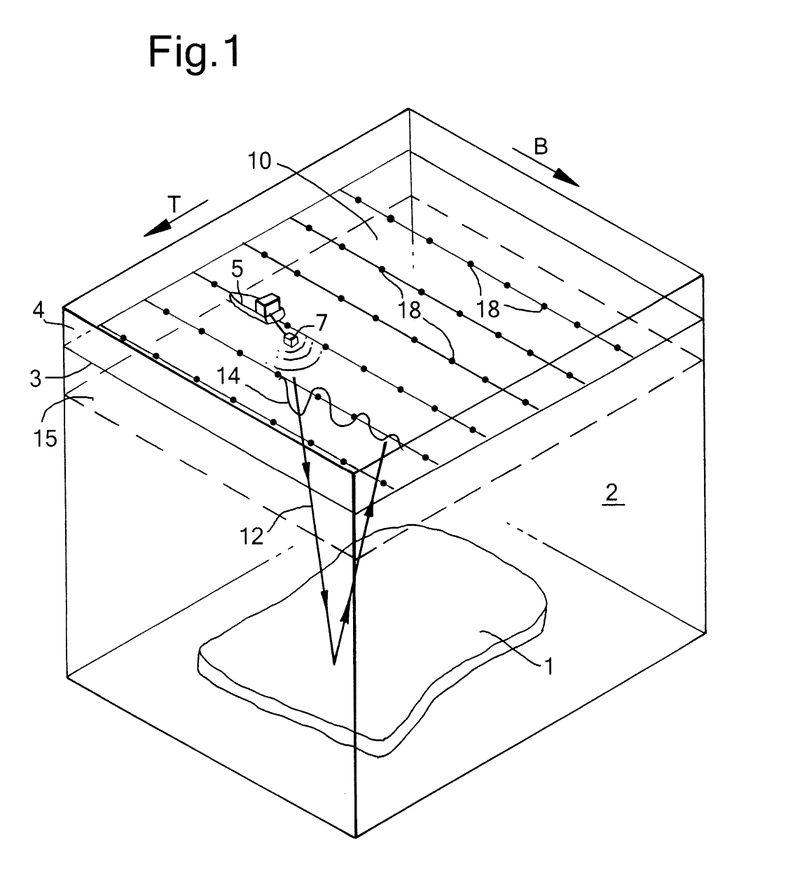

Reference is made to FIG. 1, showing schematically an example of a seismic survey of a submarine reservoir region 1 in a subsurface formation 2, located deep below the bottom 3 of the sea 4, such as at a depth of between 600 m and 5000 m, or between 1000 and 5000 m, wherein the reservoir is typically thin compared to its depth. A survey vessel 5 carrying a seismic source 7 such as an air gun navigates back and forth across the surface area 10 on the sea floor 3 above the reservoir region 1. When the source is activated, seismic body waves 12 are generated in the subsurface formation, which typically travel down to the formation region 1, and are reflected at a contrast. Also, surface waves 14 (exaggerated in the Figure for the sake of clarity) are generated in a surface region 15 and spread in two dimensions in close proximity to the earth/water interface (the bottom of the sea). Seismic receivers 18 such as geophones and/or hydrophones are arranged in this example by means of ocean bottom cables 20. A seismic receiver picks up seismic waves, and can also be for example an accelerometer, or a fibre optic device. Clearly, a seismic surface wave survey can be done in different arrangements as well. The source can be arranged on the sea surface, in the sea, or at the sea floor, and for an application on land, on or in the ground. The source can be optimised so as to preferentially generate surface waves such as by locating it close to the seafloor. Moreover it can be beneficial to use receivers that are able to measure low frequencies, such as at less than 15 Hz, or less than 10 Hz. For marine applications the source is preferably within 100 m from the sea floor, for optimum coupling of seismic energy into the subsurface formation. Instead of an active source, noise emissions from e.g. offshore platforms can be used as passive source. Seismic receivers do not need to be arranged in ocean bottom cables.

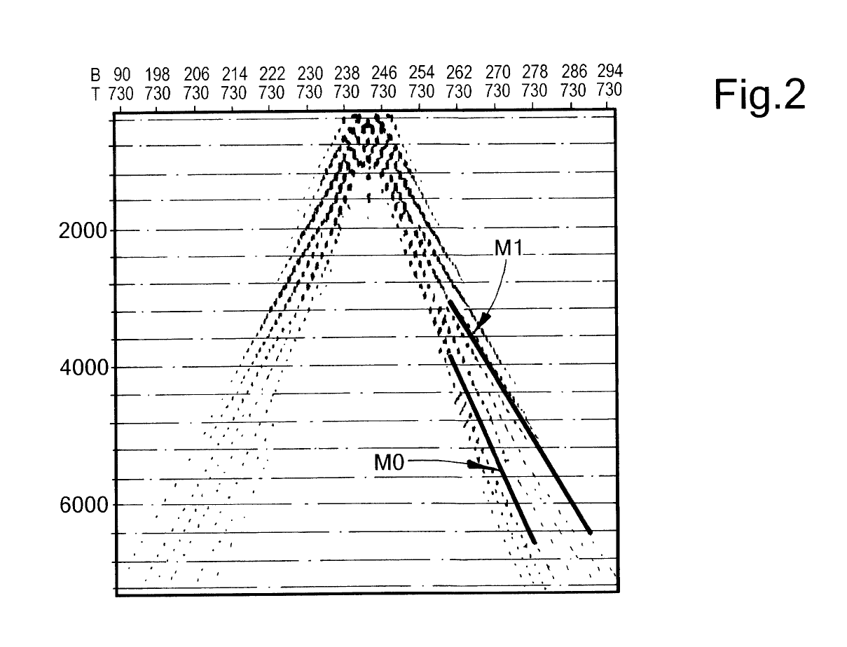

Reference is made to FIG. 2 showing an example of surface wave signals in dependence on propagation time t, acquired at a fixed receiver location. Each vertical trace corresponds to the signal for a different source position, the source is moved along a line that runs over the location of the receiver, characterized by so-called Bin (B) and Track (T) coordinates of the survey area.

The data shown in FIG. 2 have been acquired at a geophone of an ocean bottom cable. In order to suppress signals from body waves, the raw signal was bandpassed to a low frequency, ca. 4 Hz. At least the fundamental and first excited modes, M0 and M1, can be distinguished, travelling at different velocities. It was found that data obtained from a hydrophone receiver (not shown), are biased away from the fundamental mode and carry a stronger signature of the second excited mode M2.

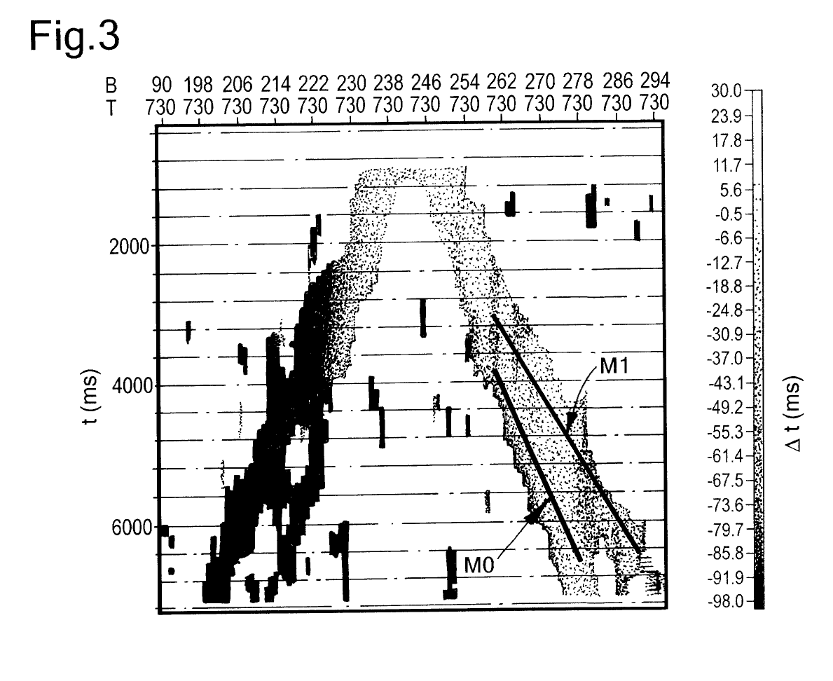

Reference is now made to FIG. 3, showing a representation of time shift At between surface wave signals at a fixed receiver location, taken at a first and second moment in time separated by approximately two years, during which time the hydrocarbon reservoir underneath was producing. Time shifts of up to 200 ms in a 6500 ms record are observed, so surface wave time shifts turn out to be very sensitive to small surface strains. Scholte waves are much more sensitive to strain than conventional body wave timeshifts. It is also seen that time shifts observed for different modes give different information. It is thought that this is due to the different probing depth of the different modes. The fundamental mode M0 probes the very near surface of typically less than 50 m, where unconsolidated sediments are present. Higher excited modes probe deeper into the surface region, up to typically 300 m.

Time shift data as in FIG. 3 can be obtained for all receiver locations and can be used in a tomographic reconstruction to obtain an areal distribution representing seismic surface velocity change. Tomographic reconstruction of surface wave signals is much more straightforward than that of body waves in normal seismics, because the receiver grid is placed in or near the surface region for which the areal distribution is to be determined. Whereas in conventional body wave tomography the sources and receivers are located at the boundaries of the investigated volume, they are now embedded in the volume (shallow surface layer) that is to be reconstructed. In particular, this makes anisotropic tomography, i.e. the determination of an areal distribution or a map of surface wave velocity and/or associated anisotropy from time-lapse measurements, much more accurate. This is because for each cell of the velocity grid to be determined, many more rays intersect and further, a wider range of angles of intersection are present, leading to a better determination of angular dependence of velocity and hence anisotropy.

Tomographic reconstruction of actual data obtained was carried out as follows: the seismic data (separately for the surveys at the first, baseline, and second, monitor, survey and for each measurable mode) were arranged in receiver gathers (all of the shots into one of the ocean-bottom receivers were arranged in a two-dimensional grid per the shot x-y location. Cross-correlation time shifts between baseline and monitor surveys were computed for each gather and written to a file, with one line entry each shot-receiver location (containing time shift and geometry information). These files were imported into a tomographic reconstruction program that attempted, using straight rays and the well-known SIRT algorithm (such as described in the paper “Comparison of ART, SIRT, Least-Squares, and SVD Two-Dimensional Tomographic Inversions of Field Data” by K J McGaughey and R. I. Young, SEG Expanded Abstracts 9, 74 (1990)), to make a least squares fit of the observed time-shifts to a change in velocity between baseline and monitor. The velocity change was sampled in a 2-dimensional regular grid that was updated in multiple iterations of the SIRT algorithm.

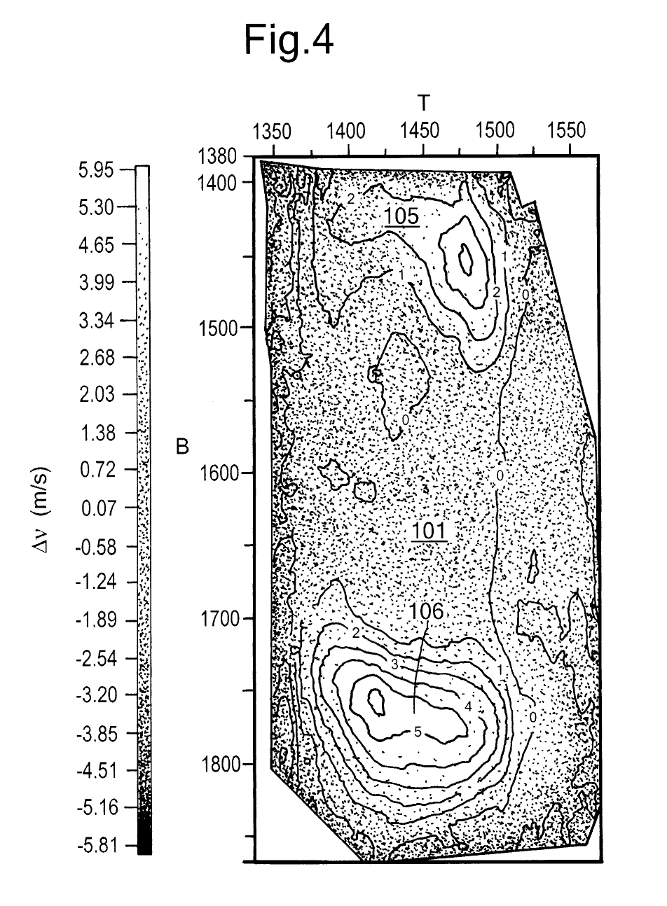

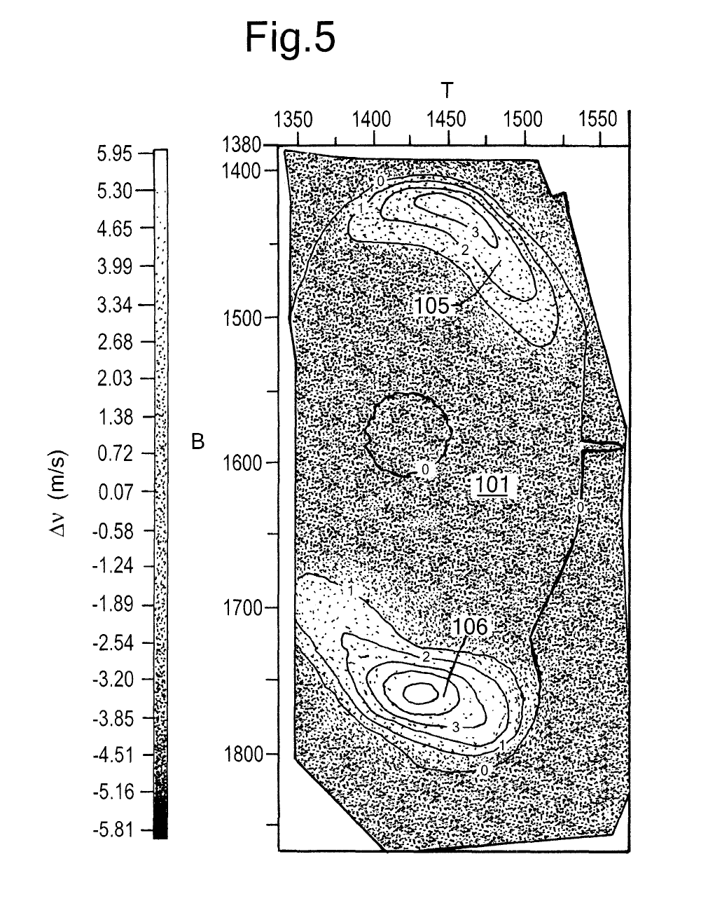

FIG. 4 shows a map of surface wave velocity change Av determined in this way for the M1 mode, probing at about 200 m below the sea floor, for an area above an actual depleting hydrocarbon reservoir region 101. Two areas 105 and 106 of the reservoir region 101 are being depleted via production wells (not shown). The Figure displays the surface velocity change over two years of production, derived from a baseline and a monitoring seismic survey. Production from the reservoir region had already started before the baseline survey. The Figure shows two areas of significant Scholte-wave velocity speedup, up to about 6 m/s increase (from an absolute velocity of about 300 m/s), corresponding to the areas 105 and 106. A speedup corresponds to compaction of the underlying reservoir, and the associated subsidence and horizontal compression at the surface, i.e. the volume change associated with production (depletion) over the two years is actually observed. The map facilitates estimating the areal extent of the depleting zones. It is noted that the Bin and Track scales of FIGS. 4 and 5 correspond to x and y directions, and use a different numbering and are not comparable to those of FIGS. 2 and 3.

FIG. 5 displays calculated Scholte wave velocity changes Δv for the same area as in FIG. 4, obtained from modeling the subsurface formation including reservoir region 101. Surface strains can be predicted by a geomechanical model, incorporating reservoir-level production effects as predicted by a state-of-the-art reservoir model. The reservoir model includes volume changes in the reservoir as fluids are removed. The volume changes lead, also in the reservoir model, to subsidence of the top of the reservoir. Geomechanic modeling is a well-known and widely used methodology. A geomechanical model is typically populated with parameters describing the elastic and compaction response of reservoir and overburden rocks in the area of interest. The output of a reservoir simulator, giving in particular strain fields at the reservoir level, as well as subsidence, is fed into a program that computes, using the input reservoir strains and rock properties, a volume triaxial strain field covering the oil field and surrounding areas that are effected by the reservoir strain and subsidence. This geomechanical simulation also gives the stress field, which can be used in place of strain to compare with seismic velocity measurements. More complex geomechanical modeling software will solve overburden and reservoir strains simultaneously with reservoir fluid flow. The stress or strain field can be used to compute changes in the elastic stiffness (and hence seismic velocity) using a non-linear, stress(/strain)-sensitive rock physics model, such as described in e.g. the paper by Herwanger et al. (see above).

One starts with a reservoir model, which includes volume changes in the reservoir as fluids are removed. The volume changes lead, also in the reservoir model, to subsidence of the top of the reservoir. The geomechanical modeling software imports the subsidence (as a map) and, using postulated rock properties in the overburden, computes differences in stresses and strains in the entire overburden due to the reservoir subsidence. So, the strain differences we use to compare with data follow deterministically from the volume changes in the reservoir.

A map of surface strains calculated in this way could already be compared with the measured Scholte wave velocity change map in FIG. 4. Going one step further, surface strains have been then converted into shear and compressional velocity differences using a fracture modeling techniques known from C. M. Sayers and M. Kachanov, “Microcrack-induced elastic wave anisotropy of brittle rocks”, Journal of Geophy. Res., vol 100, B3, pages 4149-4156. The resulting body-wave velocities are then converted to Scholte-wave velocity using a methodology described in the paper “The azimuthal dependence of Love and Rayleigh Wave propagation in slightly anisotropic medium”, M. L. Smith and F. A. Dahlen, J. Geophysical Research, vol 78, No. 17, p. 3321-3333, 1972. The results are displayed in FIG. 5. It will be understood that such manipulations of strain to determine Scholte velocity are approximate and it is likely the methodology can be refined.

The FIG. 5 shows the velocity only in one azimuthal direction. The anisotropy contribution is not shown, but it was found that this can also be measured, and it can be of interest in the practical application of the method.

In FIGS. 4 and 5 lines of equal Scholte wave velocity timeshift are indicated for several values of the timeshift in ms.

In general, good agreement between the areal distributions of the observed and calculated Scholte wave velocity changes in FIGS. 4 and 5 is seen. Clearly, there are differences as well, and it is thought that these can be minimized by refining/updating the reservoir and geomechanical models. In this way, quantitative estimates of parameters related to the volume change in the reservoir region can be estimated or verified, such as by providing constraints to their values, by using the measured Scholte wave velocity change. Relevant parameters for volume change can be porosity, compressibility, pressure, thickness, gas-oil ratio GOR.

1. A method of monitoring a subsurface formation including a region of interest below a surface region, which method comprises the steps of
exciting seismic interface waves in the surface region over an area of the earth's surface at a first and a second moment in time;
detecting seismic interface wave signals for a plurality of locations in the area;
determining, from the detected seismic interface wave signals, an areal distribution of a parameter related to seismic interface wave velocity change between the first and second moments in time; and
inferring, from the areal distribution, an indication of a volume change of the region of interest between the first and second moments in time
wherein a parameter related to a volume change is inferred from the areal distribution, using a model of the subsurface formation, in particular a geomechanical and/or reservoir model;
the areal distribution is a first areal distribution; and
the step of inferring an indication of a volume change comprises:
postulating a model for the subsurface formation including an assumption on the volume change of the region of interest between the first and second moments in time;
calculating, using the model, a second areal distribution, within the surface region of the subsurface formation above the region of interest, of a parameter related to the volume change of the region of interest between the first and second moments in time; and
comparing the first and second areal distributions so as to validate, dismiss, or refine the assumption on the volume change of the region.

2. The method according to claim 1, wherein the parameter related to volume change is selected from the group consisting of a stress change parameter, a strain, anisotropy of a seismic wave velocity, or a predicted parameter related to seismic interface wave velocity change.

3. The method according to claim 1 wherein the parameter related to seismic interface wave velocity change is seismic interface wave velocity change, or a seismic interface wave travel time change.

4. The method according to claim 1 wherein seismic surface velocity change of at least two different modes of seismic surface velocity is taken into account.

5. The method according to claim 1 wherein an estimate of at least one of compaction or expansion of the region of interest, location of a lateral edge of a the region of interest, fluid depletion or fluid enrichment of a reservoir region in the subsurface formation, fluid connectivity between a plurality of regions in the subsurface formation is inferred; in particular wherein a 1D, 2D or 3D distribution of the estimate is determined.

6. The method according to claim 1 wherein the subsurface formation comprises a reservoir region, for example a hydrocarbon reservoir, and wherein the volume change takes place in the course of production of a fluid from or injection of a fluid into the fluid reservoir, or in the course of modifying the temperature of the reservoir region.

7. The method according to claim 1 wherein a further data set is acquired for the subsurface formation, such as conventional time-lapse seismic data or geodetic deformation data of the earth's surface, and wherein the change in interface wave velocity is compared with and/or processed together with the further data set in order to infer the indication of the volume change.

8. A method for producing hydrocarbons from a subsurface formation underneath a sea bed, wherein the subsurface formation is monitored by the method of claim 1.

9. A method according to claim 1 wherein the subsurface formation is a subsea formation and wherein the earth's surface is the bottom of the sea.
